(19) United States
(12) Patent Application Publication
(10) Pub. No.: US 2025/0164629 A1
(43) Pub. Date: May 22, 2025

(54) TARGET DETECTION METHOD AND APPARATUS

(71) Applicant: SAMSUNG ELECTRO-MECHANICS CO., LTD., Suwon-si (KR)

(72) Inventors: Young Seo PARK, Suwon-si (KR); Hansang CHO, Suwon-si (KR); Kibong CHONG, Suwon-si (KR); Byonghyok CHOI, Suwon-si (KR)

(73) Assignee: SAMSUNG ELECTRO-MECHANICS CO., LTD., Suwon-si (KR)

(21) Appl. No.: 18/662,129

(22) Filed: May 13, 2024

(30) Foreign Application Priority Data
Nov. 16, 2023 (KR) 10-2023-0159021

(51) Int. Cl. G01S 13/46; G01S 13/86; G01S 13/931

(52) U.S. Cl. CPC G01S 13/46; G01S 13/867; G01S 13/931; G01S 2013/462

(57) ABSTRACT

A target detection method and apparatus are provided. The target detection apparatus includes a first radar device configured to transmit, in a first mode, radar signals within a first horizontal angle of view and a second horizontal angle of view larger than the first horizontal angle of view, and configured to transmit, in a second mode, radar signals within the second horizontal angle of view; a first camera configured to capture an image within a third horizontal angle of view in the first mode; and a second camera configured to capture an image within a fourth horizontal angle of view that is larger than the third horizontal angle of view in the second mode.

### CROSS-REFERENCE TO RELATED APPLICATIONS

This application claims the benefit under 35 USC § 119(a) of Korean Patent Application No. 10-2023-0159021 filed on Nov. 16, 2023, in the Korean Intellectual Property Office, the entire disclosure of which is incorporated herein by reference for all purposes.

### BACKGROUND

### 1. Field

The following description relates to a target detection method and apparatus.

### 2. Description of the Background

To improve the safety of vehicles and pedestrians, vehicles are equipped with various sensors such as, but not limited to, ultrasonic waves sensors, cameras, radars, and lidars that recognize or sense the surrounding environment. These sensors may detect people, vehicles, animals, and moving objects within the line of sight (LOS) area of the sensors, but may not detect people or vehicles that are obscured by buildings, walls, or adjacent vehicles. In other words, sensors equipped on vehicles may detect targets within the visible area of the sensors, but may not detect targets within the non-line of sight (NLOS) area of the sensors.

If additional sensors are used to detect targets within the NLOS area, the cost according to the additional sensors may be increased. Therefore, a method is desired to detect targets within the NLOS area by utilizing sensors implemented in vehicles to eliminate cost increases.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, a target detection apparatus includes a first radar device configured to transmit, in a first mode, radar signals within a first horizontal angle of view and a second horizontal angle of view larger than the first horizontal angle of view, and configured to transmit, in a second mode, radar signals within the second horizontal angle of view; a first camera configured to capture an image within a third horizontal angle of view in the first mode; and a second camera configured to capture an image within a fourth horizontal angle of view that is larger than the third horizontal angle of view in the second mode.

In the first mode, the first radar device may be configured to repeat an operation of transmitting a first radar signal within the first horizontal angle of view and an operation of transmitting a second radar signal within the second horizontal angle of view, and in the second mode, the first radar device may be configured to perform only the operation of transmitting the second radar signal within the second horizontal angle of view in the second mode.

The apparatus may further include a controller configured to set an operation mode to one of the first mode and the second mode based on a driving speed of a vehicle.

The controller may be configured to set the operation mode as the first mode when the driving speed of the vehicle is less than or equal to a reference speed of the vehicle, and may be configured to set the operation mode as the second mode when the driving speed of the vehicle exceeds the reference speed of the vehicle.

The radar device may be configured to alternately transmit the radar signals in a range of the first horizontal angle of view and the range of the second horizontal angle of view by changing a beamforming using a time division multiplexing (TDM) method.

The apparatus may further include a controller configured to detect a first target, in the first mode, based on radar data generated in response to a radar signal transmitted within the first horizontal angle of view and image data captured by the first camera, and configured to detect a second target based on radar data generated in response to a radar signal transmitted within the second horizontal angle of view and image data captured from the second camera.

The apparatus may further include a controller configured to detect a target based on radar data generated in response to a radar signal transmitted within the second horizontal angle of view and image data captured by the second camera, in the second mode.

The first horizontal angle of view may be less than 60 degrees, and the second horizontal angle of view may be 60 degrees or more.

The third horizontal angle of view may be less than 100 degrees, and the fourth horizontal angle of view may be 100 degrees or more.

In a general aspect, a target detection method includes receiving, by a first radar device in a first mode, radar data within a first horizontal angle of view and radar data within a second horizontal angle of view larger than the first horizontal angle of view; receiving, by the first radar device in a second mode, radar data within the second horizontal field of view; receiving, by a first camera, image data within a third horizontal angle of view in the first mode; and receiving, by a second camera, image data within a fourth horizontal angle of view that is larger than the third horizontal angle of view in each of the first mode and the second mode.

The receiving, by the first radar device, radar data in the first mode may include alternately transmitting, by the first radar device, radar signals in a range of the first horizontal angle of view and a range of the second horizontal angle of view using a time division multiplex (TDM) method by changing a beamforming; and alternately receiving, by the first radar device, radar data corresponding to a radar signal transmitted within the first horizontal angle of view and radar data corresponding to a radar signal transmitted within the second horizontal angle of view.

The method may include determining, by a controller, an operation mode as one of the first mode and the second mode based on a driving speed of a vehicle; and controlling, by the controller, the first radar device, the first camera, and the second camera based on the determined operation mode.

The determining of the operation mode by a controller may include determining the operation mode as the first mode when the driving speed of the vehicle is less than or equal to a reference speed of the vehicle; and determining the operation mode as the second mode when the driving speed of the vehicle exceeds the reference speed of the vehicle.

The method may include detecting, by a controller, a target by combining radar data within the first horizontal angle of view and image data received from the first camera in the first mode; and detecting, by the controller, a target by combining radar data within the second horizontal angle of view and image data obtained from the second camera in the first mode.

The method may include detecting, by a controller, a target by combining radar data within the second horizontal angle of view and image data received from the second camera in the second mode.

The first horizontal angle of view may be 60 degrees or less, and the second horizontal angle of view is greater than 60 degrees.

The third horizontal angle of view may be 100 degrees or less, and the fourth horizontal angle of view may be greater than 100 degrees.

Other features and aspects will be apparent from the following detailed description, the drawings, and the claims.

### BRIEF DESCRIPTION OF DRAWINGS

FIG. 1 illustrates an example target detection apparatus, in accordance with one or more embodiments.

FIG. 2 illustrates a flowchart explaining the operation of an example controller illustrated in FIG. 1.

FIG. 3 illustrates a method for detecting a target in a low-speed mode by example the controller illustrated in FIG. 1.

FIG. 4 illustrates the horizontal angle of view for detecting a target within the NLOS area by the radar illustrated in FIG. 1.

FIG. 5 illustrates a method for detecting a target within an NLOS area by utilizing the reflection characteristics of the example radar illustrated in FIG. 1.

FIG. 6 illustrates an example target detection apparatus, in accordance with one or more embodiments.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as “on,” “connected to,” “coupled to,” or “joined to” another component, element, or layer, it may be directly (e.g., in contact with the other component, element, or layer) “on,” “connected to,” “coupled to,” or “joined to” the other component element, or layer, or there may reasonably be one or more other components elements, or layers intervening therebetween. When a component or element is described as “directly on”, “directly connected to,” “directly coupled to,” or “directly joined to” another component element, or layer, there can be no other components, elements, or layers intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

One or more examples may provide a target detection method and apparatus capable of detecting a target in a non-line of sight (NLOS) area.

Now, the target detection method and apparatus according to the embodiment will be described in detail with reference to the drawings.

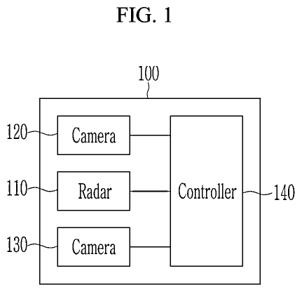

FIG. 1 illustrates an example target detection apparatus, in accordance with one or more embodiments.

Referring to FIG. 1, the target detection apparatus 100 may include a radar device 110, a camera 120, a camera 130, and a controller 140.

The radar device 110 may transmit radar signals according to control signals received from the controller 140. Radar device 110 may be mounted at a predetermined location in the vehicle. In a non-limited example, the radar device 110 may be mounted at the bumper location of a vehicle. The radar device 110 may detect a target within the range of a first horizontal angle of view and the range of a second horizontal angle of view. In an example, the second horizontal angle of view may be larger than the first horizontal angle of view.

The horizontal angle of view of a long-range radar that detects targets at a long distance may generally be less than 30 degrees. The horizontal angle of view of a mid-range radar that detects targets at a mid-range may be around 60 degrees, and the horizontal angle of view of a short-range radar that detects targets at a short range may be more than 120 degrees.

According to an embodiment, the first horizontal angle of view may be less than 60 degrees, and the second horizontal angle of view may be 60 degrees or more. According to another embodiment, the first horizontal angle of view may be 60 degrees or less, and the second horizontal angle of view may be greater than 60 degrees.

According to another embodiment, the first horizontal angle of view may be 30 degrees or less, and the second horizontal angle of view may be 120 degrees or more.

According to another embodiment, the first horizontal angle of view may be 40 degrees or less, and the second horizontal angle of view may be 140 degrees or more.

The radar device 110 may transmit radar signals within the first horizontal angle of view or within the second horizontal angle of view through beamforming of radar signals transmitted through a plurality of transmission antennas.

According to an embodiment, the radar device 110 may alternately perform an operation of transmitting radar signals within the first horizontal angle of view and an operation of transmitting radar signals within the second horizontal angle of view according to a control signal from the controller 140. The radar device 110 may only perform an operation of transmitting radar signals only within the second horizontal angle of view according to a control signal from the controller 140.

In some embodiments, the radar device 110 may alternately perform an operation of transmitting radar signals within the first horizontal angle of view and an operation of transmitting radar signals within the second horizontal angle of view, in a low-speed mode. In an example, the radar device may perform an operation of transmitting radar signals only within the second horizontal angle of view in a high-speed mode. The radar device 110 may alternately transmit radar signals within the first horizontal field of view and within the second horizontal field of view using a time division multiplexing (TDM) method by changing beamforming in the low-speed mode.

The radar device 110 may generate radar data based on signals received in response to the transmission of radar signals. The radar device 110 may generate radar data based on signals received in response to radar signals transmitted within the first horizontal field of view, and may generate radar data based on signals received in response to radar signals transmitted within the second horizontal field of view.

The camera 120 may have a third horizontal angle of view, may operate according to a control signal from the controller 140, and may capture images within the third horizontal angle of view. In an example, the camera 120 may operate only in a low-speed mode.

The camera 130 may have a fourth horizontal angle of view, may operate according to a control signal from the controller 140, and may capture images within the fourth horizontal angle of view that is larger than the third horizontal angle of view. In an example, the camera 130 may operate in both a low-speed mode and a high-speed mode.

According to the embodiment, the camera 120 and the camera 130 may capture the front area of the vehicle. In an example, the camera 120 may capture images within the third horizontal angle of view, and the camera 130 may capture an image within the fourth horizontal angle of view. The camera 120 and camera 130 may be mounted at a location where the front area of the vehicle may be captured.

Typically, the horizontal angle of view of a long-distance camera may be 30 degrees or less, the horizontal angle of view of a mid-range camera may be around 60 degrees, and the horizontal angle of view of a short-range camera may be 120 degrees or more.

According to one embodiment, the third horizontal angle of view of the camera 120 may be less than 100 degrees, and the fourth horizontal angle of view of the camera 130 may be 100 degrees or more. The third horizontal angle of view of the camera 120 may be 100 degrees or less, and the fourth horizontal angle of view of the camera 130 may be greater 100 degrees.

According to another embodiment, the third horizontal viewing angle of the camera 120 may be 60 degrees or less, and the fourth horizontal viewing angle of the camera 130 may be 120 degrees or more.

According to another embodiment, the third horizontal view angle of the camera 120 may be 70 degrees or less, and the fourth horizontal view angle of the camera 130 may be 180 degrees or more.

The controller 140 may control the operations of the radar device 110, the camera 120, and the camera 130. The controller 140 may control the operations of the radar device 110, the camera 120, and the camera 130 by transmitting control signals to each of the radar device 110, the camera 120, and the camera 130.

The controller 140 may receive the driving speed of the vehicle. The controller 140 may control the operations of the radar device 110, the camera 120, and the camera 130 based on the driving speed of the vehicle.

In an example, if the driving speed of the vehicle is faster than a predetermined reference speed, the controller 140 may determine the operation mode for target detection as a high-speed mode, and may generate control signals to be transmitted to the radar device 110, the camera 120, and the camera 130 based on the high-speed mode. The controller 140 may transmit control signals according to the high-speed mode to the radar device 110, the camera 120, and the camera 130. The reference speed may be set to 30 km/h, as a non-limited example. The control signal according to the high-speed mode transmitted to the radar device 110 may include information instructing operation at the second horizontal angle of view, and the control signal according to the high-speed mode transmitted to the camera 130 may include information instructing the start of operation. The control signal according to the high-speed mode transmitted to the camera 120 may include information instructing to stop an operation. Accordingly, the controller 140 may obtain radar data generated in response to radar signals transmitted within the second horizontal angle of view and image data captured within the fourth horizontal angle of view in the high-speed mode.

As another example, if the driving speed of the vehicle is slower than the reference speed, the controller 140 may determine the operation mode as a low-speed mode, and may generate control signals to be transmitted to the radar device 110, the camera 120, and the camera 130 based on the determined low-speed mode. The controller 140 may transmit control signals according to the low-speed mode to the radar device 110, the camera 120, and the camera 130. The control signal according to the low-speed mode transmitted to the radar device 110 may include information instructing a combination of operations at the first horizontal angle of view and the second horizontal angle of view, and the control signal according to the low-speed mode transmitted to the camera 120 may include information instructing the start of the operation.

The control signal according to the low-speed mode transmitted to the camera 130 may include information instructing the start of an operation. When the radar device 110 receives information instructing a combination of operations at the first horizontal angle of view and the second horizontal angle of view, the radar device 110 may alternately perform an operation of transmitting radar signals within the first horizontal angle of view and an operation of transmitting radar signals within the second horizontal angle of view in the low-speed mode. In an example, while operating in the low-speed mode, the order or ratio of the operation of transmitting the radar signal within the first horizontal angle of view and the operation of transmitting the radar signal within the second horizontal angle of view may be arbitrarily set. Accordingly, in the low-speed mode, the controller 140 may obtain radar data generated in response to radar signals transmitted within the first horizontal angle of view, radar data generated in response to radar signals transmitted within the second horizontal angle of view, image data captured within the third horizontal angle of view, and image data captured within the fourth horizontal angle of view.

The controller 140 may detect a target using at least one among radar data generated within the first horizontal angle of view, radar data generated within the second horizontal angle of view, image data captured within the third horizontal angle of view, and image data captured within the fourth horizontal angle of view.

According to the embodiment, the controller 140 may combine or fuse the radar data received from the radar device 110 and the images received from the camera 120 and the camera 130, and may detect targets in the line of sight (LOS) area and non-line of sight (NLOS) area using the combined or fused data.

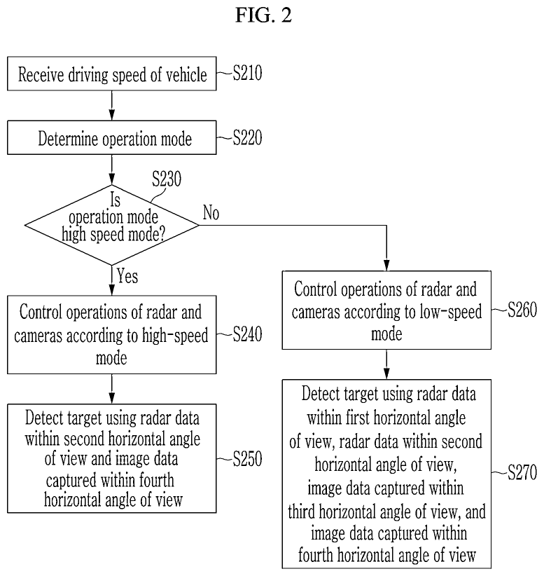

FIG. 2 is a flowchart explaining the operation of the controller shown in FIG. 1, in accordance with one or more embodiments. The operations in FIG. 2 may be performed in the sequence and manner as shown. However, the order of some operations may be changed, or some of the operations may be omitted, without departing from the spirit and scope of the shown example. Additionally, operations illustrated in FIG. 2 may be performed in parallel or simultaneously. One or more blocks of FIG. 2, and combinations of the blocks, can be implemented by special purpose hardware-based computer that perform the specified functions, or combinations of special purpose hardware and instructions, e.g., computer or processor instructions. In addition to the description of FIG. 2 below, the descriptions of FIG. 1 are also applicable to FIG. 2 and are incorporated herein by reference. Thus, the above description may not be repeated here for brevity purposes. The operations of FIG. 2 may be performed by a processor.

Referring to FIG. 2, the controller 140 may receive the driving speed of the vehicle (operation S210).

The controller 140 may determine an operation mode for target detection based on the driving speed of the vehicle (operation S220). The controller 140 may determine the operation mode as a low-speed mode if the driving speed of the vehicle is less than or equal to a reference speed, and may determine the operation mode as a high-speed mode if the driving speed of the vehicle exceeds the reference speed.

When the operation mode is the high-speed mode (operation S230), the controller 140 may control the operations of the radar device 110, the camera 120, and the camera 130 according to the high-speed mode (operation S240).

According to an embodiment, in the example of the high-speed mode, the controller 140 may transmit a control signal including information instructing an operation at the second horizontal angle of view to the radar device 110, may transmit a control signal including information instructing operation start to the camera 130, and may transmit a control signal including information instructing to stop operation to the camera 120.

The radar device 110 may transmit radar signals within the second horizontal angle of view through beamforming according to the control signal from the controller 140, may generate radar data within the second horizontal angle of view by processing the received radar signals, and may transmit the generated radar data within the second horizontal angle of view to the controller 140.

The camera 130 may capture images within the third horizontal angle of view according to a control signal from the controller 140 and transmit the captured image data to the controller 140.

In high-speed mode, the controller 140 may detect a target using the radar data generated from the radar device 110 within the second horizontal angle of view and the image data captured within the fourth horizontal angle of view (operation S250).

When the operation mode is the low-speed mode (operation S230), the controller 140 may control the operations of the radar device 110, the camera 120, and the camera 130 according to the low-speed mode (operation S260).

According to an embodiment, in the example of the low-speed mode, the controller 140 may transmit a control signal including information instructing a combination of operations at the first horizontal angle of view and the second horizontal angle of view to the radar device 110, and may transmit control signals including information instructing the start of an operation to the camera 120 and the camera 130.

The radar device 110 may alternately perform an operation of transmitting radar signals within the first horizontal angle of view and an operation of transmitting radar signals within the second horizontal angle of view according to the control signal from the controller 140. The radar device 110 may generate radar data within the first horizontal angle of view by processing radar signals received in response to radar signals transmitted within the first horizontal angle of view, and may generate radar data within the second horizontal angle of view by processing radar signals received in response to radar signals transmitted within the second horizontal angle of view. The radar device 110 may transmit radar data within the first horizontal angle of view and radar data within the second horizontal angle of view to the controller 140. For example, the radar device 110 having a frame rate of 20 fps may obtain 20 pieces of radar data per second, and among the 20 pieces of radar data, 10 pieces of radar data may be data obtained within the first horizontal angle of view, and the remaining 10 pieces of radar data may be obtained within the second horizontal angle of view.

The camera 120 may capture images within the third horizontal angle of view according to a control signal received from the controller 140, and transmit image data captured within the third horizontal angle of view to the controller 140.

The camera 130 may capture images within the fourth horizontal angle of view according to the control signal received from the controller 140 and transmit image data captured within the fourth horizontal angle of view to the controller 140.

In the low-speed mode, the controller 140 detect a target using the radar data generated from the radar device 110 within the first horizontal angle of view, the radar data generated from the radar device 110 within the second horizontal angle of view, image data captured within the third horizontal angle of view, and image data captured within the fourth horizontal angle of view (S270).

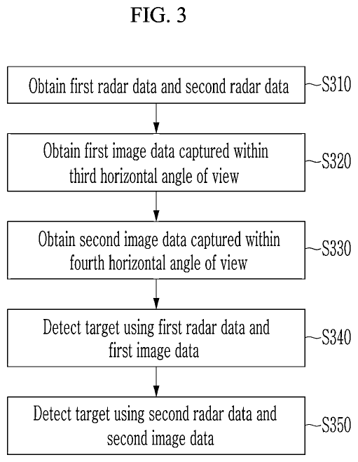

FIG. 3 is a flowchart illustrating a method for detecting a target in a low-speed mode by the controller shown in FIG. 1, in accordance with one or more embodiments. The operations in FIG. 3 may be performed in the sequence and manner as shown. However, the order of some operations may be changed, or some of the operations may be omitted, without departing from the spirit and scope of the shown example. Additionally, operations illustrated in FIG. 3 may be performed in parallel or simultaneously. One or more blocks of FIG. 3, and combinations of the blocks, can be implemented by special purpose hardware-based computer that perform the specified functions, or combinations of special purpose hardware and instructions, e.g., computer or processor instructions. In addition to the description of FIG. 3 below, the descriptions of FIGS. 1-2 are also applicable to FIG. 3 and are incorporated herein by reference. Thus, the above description may not be repeated here for brevity purposes. The operations of FIG. 3 may be performed by a processor.

Referring to FIG. 3, the controller 140 may obtain radar data within the first horizontal angle of view and radar data within the second horizontal angle of view from the radar device 110 (operation S310). For convenience of explanation, radar data within the first horizontal angle of view is referred to as first radar data, and radar data within the second horizontal angle of view is referred to as second radar data.

The controller 140 may obtain image data captured within the third horizontal angle of view from the camera 120 (operation S320). The image data captured within the third horizontal angle of view from the camera 120 is referred to as first image data.

The controller 140 may obtain image data captured within the fourth horizontal angle of view from the camera 130 (operation S330). The image data captured within the fourth horizontal viewing angle from the camera 130 is referred to as second image data.

The controller 140 may detect the target by combining the first radar data and the first image data (operation S340).

The controller 140 may detect the target by combining the second radar data and the second image data (operation S350).

According to an embodiment, the controller 140 may detect the target using radar data and image data obtained within a similar horizontal angle of view.

In the low-speed mode, there may be first radar data generated by the radar device 110 within a first horizontal angle of view (e.g., 30 degrees) and second radar data generated within a second horizontal angle of view (e.g., 120 degrees), and there may be first image data captured within a third horizontal angle of view (for example, 60 degrees) by the camera 120 and second image data captured within a fourth horizontal angle of view (for example, 120 degrees) by the camera 130.

The controller 140 may detect a target using first radar data corresponding to the narrow-angle area among the first radar data and the second radar data, and first image data corresponding to the narrow-angle area among the first image data and the second image data. The controller 140 may detect a target in the NLOS area using first radar data and first image data corresponding to the narrow-angle area.

In addition, the controller 140 may detect a target using second radar data corresponding to the wide-angle area among the first radar data and the second radar data, and second image data corresponding to the wide-angle area among the first image data and the second image data. The controller 140 may detect a target in the LOS area using second radar data and second image data corresponding to the wide-angle area.

If the horizontal angle of view of the radar device 110 and the horizontal angle of view of the camera 120 or the camera 130 are similar, the area sensed detected by the radar device 110 and the camera 120 or 130 may also be similar, and the probability of detecting the same target in a similar area may also increase. The cameras 120 and 130 and the radar device 110 may compensate for disadvantages of each camera. For example, the cameras 120 and 130 may be greatly affected by external environments such as fog or snow, but the radar device 110 may be robust to the external environment. Accordingly, the controller 140 may improve target detection accuracy while compensating for the disadvantage of cameras and radar by using radar data and image data obtained in a similar horizontal field of view.

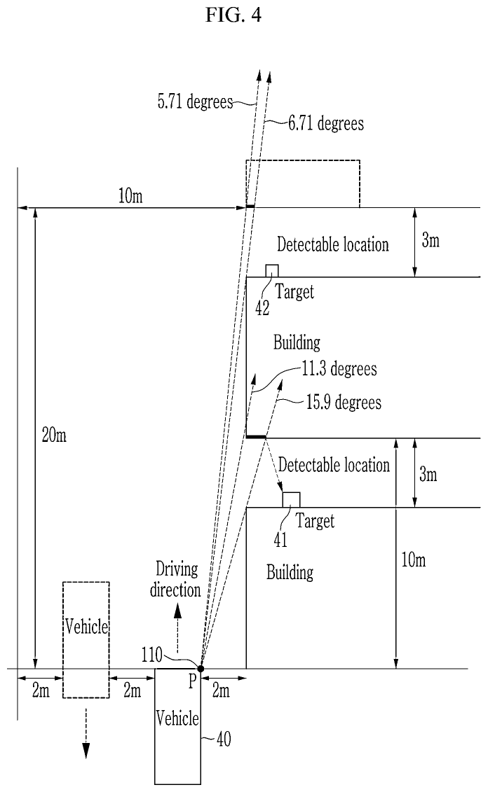

FIG. 4 illustrates the horizontal angle of view to detect a target within the NLOS area by the radar illustrated in FIG. 1.

Referring to FIG. 4, it is assumed that the width of the roadway is 10 m, the gap between the vehicle 40 and the building is 2 m, the gap between the buildings is 3 m, the width of one building is 7 m, and the radar device 110 was disposed at the P location of the vehicle 40.

The targets 41 and 42 in the NLOS area may be obscured by obstacles such as buildings or other vehicles. There is a high probability that the targets 41 and 42 in the NLOS area are located in a direction of 5 to 25 degrees from the front of the vehicle 40 based on the radar device 110 mounted on the vehicle 50. Accordingly, the radar device 110 may detect a target in the NLOS area when it has a horizontal angle of view of 30 degrees. For example, the target 41 in the NLOS area is in a detectable location from radar data obtained within a horizontal angle of view of 15.9 degrees based on the radar device 110, and the target 42 in the NLOS area is in a detectable location from radar data obtained within a horizontal angle of view of 6.71 degrees. Accordingly, the radar device 110 may detect all targets 41 and 42 in the NLOS area by using radar data obtained within a horizontal angle of view of 30 degrees.

Meanwhile, in a high-speed mode, it may be difficult to detect targets 41 and 42 in the NLOS area. Additionally, the horizontal angle of view of 120 degrees has poor resolution, so detection of targets 41 and 42 in the NLOS area may be difficult.

According to an embodiment, radar data obtained within a horizontal angle of view of 30 degrees in low-speed mode may be used to detect targets in the NLOS area.

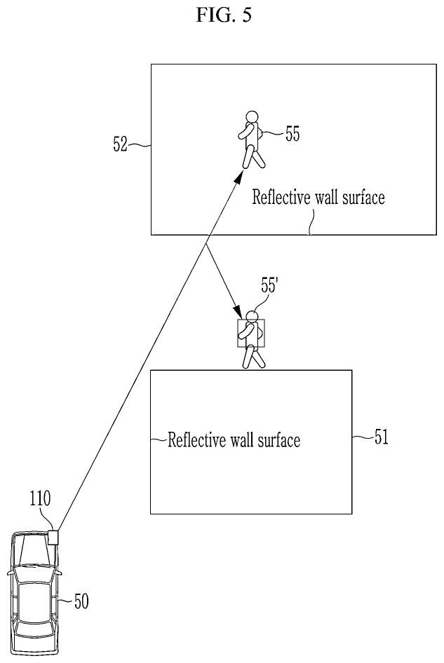

FIG. 5 illustrates a method for detecting a target within an NLOS area by utilizing the reflection characteristics of the radar illustrated in FIG. 1.

In FIG. 5, it is assumed that an obstacle 51 is disposed on the right in the driving direction of the vehicle 50, an obstacle 52 is disposed on the front right, and the target 55 is obscured by the obstacle 52.

Referring to FIG. 5, the radar device 110 mounted on the vehicle 10 may obtain radar data for the target 55 based on the radar signals reflected by the obstacle 52.

The controller 140 may detect the target 55 by obtaining radar data for the target 55 from the radar device 110.

However, the radar data obtained by the radar device 110 is not data based on direct radar signals, but may be data based on a radar signal reflected by the wall of the obstacle 52. That is, based on the wall where the signal is reflected, the controller 140 may recognize a location of the ghost target 55′ beyond the wall in a continuous line between the radar device 110 mounted on the vehicle 50 and the wall as the location of the actual target 55. Accordingly, the controller 140 may detect the location of the actual target 55 by mirroring the location of the recognized ghost target 55′ based on the location of the reflective wall surface that reflects the radar signal.

In an example, the controller 140 may use the first image data obtained through the camera 120 to more accurately detect the location of the actual target 55. As an example, the controller 140 detects the location of the target using radar data generated within the first horizontal angle of view of the radar device 110, but if the target is not detected in the first image data obtained through the camera 120, it may be determined that the target is in the NLOS area. The controller 140 may determine that the target detected from the radar data is a ghost target 55′, and may detect the location of the actual target 55 by mirroring the location of the ghost target 55′ based on the location of the reflective wall surface.

The target detection method shown in FIG. 5 may be an example, and other methods using radar data may be used.

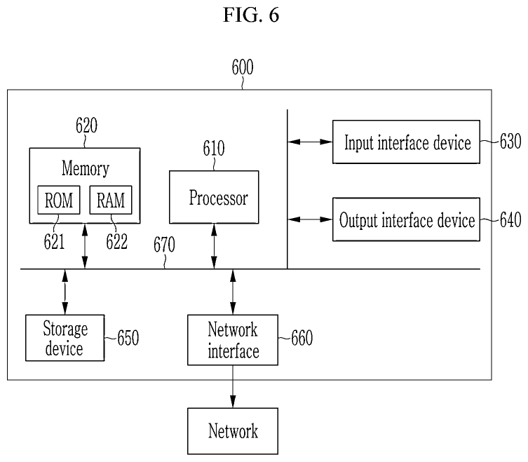

FIG. 6 illustrates an example target detection apparatus, in accordance with one or more embodiments.

Referring to FIG. 6, the example target detection apparatus 600 may represent a computing device in which the target detection method described above is implemented.

The target detection apparatus 600 may include at least one processor 610, a memory 620, an input interface device 630, an output interface device 640, a storage device 650, and a network interface device 660. Each component may be connected by a bus 670 and may communicate with each other. Additionally, each component may be connected through an individual interface or individual bus centered on the processor 610, rather than the common bus 670.

The processor 610 may be implemented as various types such as an application processor (AP), a central processing unit (CPU), a graphics processing unit (GPU), etc., and may be any semiconductor device that executes a command stored in the memory 620 or storage device 650. The processor 610 may execute program commands stored in at least one of the memory 620 and the storage device 650. The processor 610 stores program commands for implementing at least some functions of the controller 140 described with reference to FIG. 1 in the memory 620, and may control to perform the operation described with reference to FIGS. 1 to 5.

The memory 620 and storage device 650 may include various types of volatile or non-volatile storage media. For example, the memory 620 may include read-only memory (ROM) 621 and random-access memory (RAM) 622. The memory 620 may be disposed inside or outside the processor 610, and the memory 620 may be connected to the processor 610 through various known means.

The input interface device 630 may be configured to provide data to the processor 610. The input interface device 630 may provide radar data and image data to the processor 610.

The output interface device 640 may be configured to output data from the processor 610. The output interface device 640 may output target detection results.

The network interface device 660 may transmit or receive signals to and from external devices through a wired network or wireless network.

According to at least one of the embodiments, targets in the LOS area and NLOS area may be detected using one radar and two cameras.

According to at least one of the embodiments, in combining radar data generated by a radar and image data generated by a camera, accuracy of the target detection may be increased by combining radar data and image data generated at similar horizontal angle of view.

At least some of the target detection methods according to embodiments may be implemented as a program or software running on a computing device, and the program or software may be stored in a computer-readable medium.

Additionally, at least some of the target detection methods according to embodiments may be implemented as hardware that may be electrically connected to a computing device.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A target detection apparatus, comprising:
a first radar device configured to transmit, in a first mode, radar signals within a first horizontal angle of view and a second horizontal angle of view larger than the first horizontal angle of view, and configured to transmit, in a second mode, radar signals within the second horizontal angle of view;
a first camera configured to capture an image within a third horizontal angle of view in the first mode; and
a second camera configured to capture an image within a fourth horizontal angle of view that is larger than the third horizontal angle of view in the second mode.

2. The apparatus of claim 1, wherein in the first mode, the first radar device is configured to repeat an operation of transmitting a first radar signal within the first horizontal angle of view and an operation of transmitting a second radar signal within the second horizontal angle of view, and
wherein in the second mode, the first radar device is configured to perform only the operation of transmitting the second radar signal within the second horizontal angle of view in the second mode.

3. The apparatus of claim 1, further comprising:
a controller configured to set an operation mode to one of the first mode and the second mode based on a driving speed of a vehicle.

4. The apparatus of claim 3, wherein the controller is configured to set the operation mode as the first mode when the driving speed of the vehicle is less than or equal to a reference speed of the vehicle, and is configured to set the operation mode as the second mode when the driving speed of the vehicle exceeds the reference speed of the vehicle.

5. The apparatus of claim 1, wherein the radar device is configured to alternately transmit the radar signals in a range of the first horizontal angle of view and the range of the second horizontal angle of view by changing a beamforming using a time division multiplexing (TDM) method.

6. The apparatus of claim 1, further comprising a controller configured to detect a first target, in the first mode, based on radar data generated in response to a radar signal transmitted within the first horizontal angle of view and image data captured by the first camera, and configured to detect a second target based on radar data generated in response to a radar signal transmitted within the second horizontal angle of view and image data captured from the second camera.

7. The apparatus of claim 1, further comprising a controller configured to detect a target based on radar data generated in response to a radar signal transmitted within the second horizontal angle of view and image data captured by the second camera, in the second mode.

8. The apparatus of claim 1, wherein the first horizontal angle of view is less than 60 degrees, and the second horizontal angle of view is 60 degrees or more.

9. The apparatus of claim 1, wherein the third horizontal angle of view is less than 100 degrees, and the fourth horizontal angle of view is 100 degrees or more.

10. A target detection method, comprising:
receiving, by a first radar device in a first mode, radar data within a first horizontal angle of view and radar data within a second horizontal angle of view larger than the first horizontal angle of view;
receiving, by the first radar device in a second mode, radar data within the second horizontal field of view;
receiving, by a first camera, image data within a third horizontal angle of view in the first mode; and
receiving, by a second camera, image data within a fourth horizontal angle of view that is larger than the third horizontal angle of view in each of the first mode and the second mode.

11. The method of claim 10, wherein:
the receiving, by the first radar device, radar data in the first mode comprises:
alternately transmitting, by the first radar device, radar signals in a range of the first horizontal angle of view and a range of the second horizontal angle of view using a time division multiplex (TDM) method by changing a beamforming; and
alternately receiving, by the first radar device, radar data corresponding to a radar signal transmitted within the first horizontal angle of view and radar data corresponding to a radar signal transmitted within the second horizontal angle of view.

12. The method of claim 10, further comprising:
determining, by a controller, an operation mode as one of the first mode and the second mode based on a driving speed of a vehicle; and
controlling, by the controller, the first radar device, the first camera, and the second camera based on the determined operation mode.

13. The method of claim 12, wherein:
the determining of the operation mode by a controller comprises:
determining the operation mode as the first mode when the driving speed of the vehicle is less than or equal to a reference speed of the vehicle; and
determining the operation mode as the second mode when the driving speed of the vehicle exceeds the reference speed of the vehicle.

14. The method of claim 10, further comprising:
detecting, by a controller, a target by combining radar data within the first horizontal angle of view and image data received from the first camera in the first mode; and
detecting, by the controller, a target by combining radar data within the second horizontal angle of view and image data obtained from the second camera in the first mode.

15. The method of claim 10, further comprising:
detecting, by a controller, a target by combining radar data within the second horizontal angle of view and image data received from the second camera in the second mode.

16. The method of claim 10, wherein the first horizontal angle of view is 60 degrees or less, and the second horizontal angle of view is greater than 60 degrees.

17. The method of claim 10, wherein the third horizontal angle of view is 100 degrees or less, and the fourth horizontal angle of view is greater than 100 degrees.
